(19) United States
(12) Patent Application Publication
(10) Pub. No.: US 2024/0014409 A1
(43) Pub. Date: Jan. 11, 2024

(54) Electrode For A Redox Flow Battery, Redox Flow Battery And Hydrogen Generation With A Redox Flow Battery

(71) Applicant: CMBlu Energy AG, Alzenau (DE)

(72) Inventors: Peter GEIGLE, Alzenau (DE); Kilian FRIESE, Seligenstadt (DE); Nils WEDLER, Ladenburg (DE); Dennis PRZYGODDA, Crailsheim (DE); Nis-Julian KNEUSELS, Mainhausen (DE); Isabel SCHEIBEL, Alzenau (DE); Jan HARTWIG, Alzenau (DE)

(21) Appl. No.: 18/036,558

(22) PCT Filed: Dec. 9, 2021
(86) PCT No.: PCT/EP2021/085110

§ 371 Date: May 11, 2023

(30) Foreign Application Priority Data
Dec. 10, 2020 (WO) PCT/EP2020/085511

(51) Int. Cl. H01M 4/90; H01M 8/18; H01M 4/86; H01M 4/96

(52) U.S. Cl. CPC H01M 4/905; H01M 8/188; H01M 4/9075; H01M 4/8673; H01M 4/96; H01M 4/9083

(57) ABSTRACT

The present invention relates to the field of redox flow batteries and combines the conventional use of a redox flow battery for electrochemical energy storage with the production of hydrogen as additional energy storage system. Accordingly, the present invention provides an electrode for a redox flow battery, which is suitable for such dual use as well as a respective redox flow battery. The present invention also provides a method for generating hydrogen with a redox flow battery. Such a method is useful for energy storage during daily as well as seasonal fluctuations in energy production.

The present invention relates to the field of redox flow batteries and combines the conventional use of a redox flow battery for electrochemical energy storage with the production of hydrogen as additional energy storage system. Accordingly, the present invention provides an electrode for a redox flow battery, which is suitable for such dual use as well as a respective redox flow battery. The present invention also provides a method for generating hydrogen with a redox flow battery. Such a method is useful for energy storage during daily as well as seasonal fluctuations in energy production.

In recent years, concerns resulting from environmental consequences of exploiting fossil fuels as the main energy sources have led to an increasing demand of renewable energy systems e.g. solar and wind power generation. The intermittent nature of renewable energy sources, however, leaves two major challenges to fully integrate these energy sources into electrical grids. The first is the intermittent nature due to the day and night cycle, as wind and sun derived energy drastically change over the 24 h day cycle. The second is the seasonal change in available wind and sun energy, i.e. over weeks or several months.

A solution for balancing fluctuations over a short-term (e.g., 1-24 hours) storage are large-scale electrical energy storage systems, which are vital for distributed power generation development and grid stabilization. One of the most promising technologies in this field are redox-flow batteries (RFBs), first developed by NASA during the 1970's. RFBs are electrochemical systems that can repeatedly store and convert electrical energy to chemical energy and vice versa. Redox reactions are employed to store energy in the form of a chemical potential in liquid electrolyte solutions, which are pumped through electrochemical cells. To meet the worldwide need for energy storage systems, which exceeds the multi TWh capacity, a resource in the multi-million-ton scale is needed. Redox active organic molecules are promising electrolytes for RFBs that can fulfil the required demand (Z. Yang, L. Tong, D. P. Tabor, E. S. Beh, M. -A. Goulet, D. D. Porcellinis, A. Aspuru-Guzik, R. G. Gordon, M. J. Aziz, Adv. Energy Mater. 2017, 1702056; Y. Ji, M. -A. Goulet, D. A. Pollack, D. G. Kwabi, S. Jin, D. D. Porccellinis, E. F. Kerr, R. G. Gordon, M. J. Aziz, Adv. Energy Mater. 2019, 9, 1900039). Although the organic RFB is an ideal technology for stationary electrical energy storage, so far no commercially feasible solution for seasonal energy storage was suggested (A. Yilanci, I. Dincer, H. K. Ozturk, Progress in Energy and Combustion Science 2009, 35, 231-244). In contrast to batteries with solid cathode/anode materials, flow batteries age throughout the timespan they remain in the charged state rather than with the number of cycles. Therefore, for optimal battery lifetime, these systems would have to be cycled (and therefore discharged) as quickly as possible and would not be considered for seasonal energy storage systems but rather for energy storage for several hours.

To take on the challenge of seasonal energy storage, technologies with a higher energy density and better lifetime of the energy storage itself are required. In this case, power to X, such as power to hydrogen, are currently the most prominent technologies in this field, as hydrogen can in principal be stored for an indefinite time period. In such systems, excess electrical energy is converted into energy rich gases or liquids that can be stored over a longer period of time. The material can then be converted to heat or electricity (P. P. Edwards, V. L. Kuznetsov, W. I. F. David, N. P. Brandon, Energy Policy 2008, 36, 4356-4362). During periods of energy overproduction excess electrical energy can be used to electrolyse water and produce hydrogen.

Conventionally hydrogen is obtained from hydrocarbons like fossil fuels and is mainly used by the chemical industry as a basic material and in oil refining. The usage of hydrogen as energy storage is receiving more attention while the expansion of renewable energies is progressing and the storage of excess energy of the volatile electricity sources is seen as one of the key elements of the energy turnaround. The dissociation of water molecules into hydrogen and oxygen molecules using electricity by electrolysis is a process that has been known for over 200 years. Since then three major technologies have evolved: alkaline electrolysis (AEC), proton exchange membrane electrolysis (PEMEC) and solid oxide electrolyzer cells (SOEC). Among them, AEC is the most mature technology and allows large scale electrolysis plants. The underlying electrochemical principle and experimental setup of AEC electrolysers is related aqueous redox flow batteries. The PEMEC and SOEC are less developed than the alkaline electrolysis, both have a different component compared with redox flow batteries. Consequently, these processes cannot be implemented into hardware of a redox flow battery as a second and alternative method of storing energy.

In alkaline electrolysis, the anode and cathode are immersed in an aqueous alkaline solution (usually potassium hydroxide KOH), which increases the water conductivity. The two electrodes are separated by an ion-conducting membrane through which hydroxide ions (OH⁻) can diffuse. When a voltage of minimum 1.23V is applied, these are formed on the side of the cathode, where the water is split into atomic hydrogen and hydroxide ions (equation 1). As the hydroxyl ions migrate through the membrane to the anode side, the hydrogen atoms combine to form hydrogen molecules (H₂) and rise as a gas. At the anode, the hydroxide ions react to form oxygen molecules (O₂) by oxidation of water (equation 2). During operation, water is pumped to the two electrodes.

Cathode: 2H₂O+2e⁻→H₂+2OH⁻ (1)

Anode: 2OH⁻→½O₂+H₂O+2e⁻ (2)

Net Reaction: H₂O→2H₂+½O₂ (3)

AEC is usually operated at 60-80° C. and a pressure of up to 60 bar can be reached. At a cell voltage of 1.8-2.2 V, current densities of less than 0.6 A/cm are achieved. Since the cell voltage rises sharply at higher current densities, electrode materials are being researched that do not exhibit this property and thus exhibit higher cell efficiency. The system efficiency of commercial plants is currently 67-82% with a power consumption of 4.4-6.0 kWh/Nm³_{(hydrogen)}.

Alkaline electrolysis has already found application in test and demonstration plants with renewable energies. The dynamic operation of the technology plays an important role in this application. The alkaline electrolysis cells can follow small and large current changes without much delay. However, the necessary system components such as lye pump, pressure regulator and product gas separators, which cannot directly follow the rapid load changes, are problematic. The cells themselves suffer from many rapid load changes, which are accompanied by strong temperature changes. This puts stress on the materials, which leads to premature aging. Furthermore, the AEC has only a limited overload capacity, with a maximum of 50% of the normal load. The lower partial load is at least in the range of 10-20% of the normal load. During prolonged operation in the low load range, the gas quality deteriorates marginally as foreign gases are dissolved in the electrolyte flow. New anion exchange membranes are already being researched and tested to solve this problem. Another problem of the dynamic operation of the AEC is frequent switching on and off of the plant. To start up and shut down the electrolytes have to be tempered and the system has to be flushed with nitrogen. This results in a cold start time of up to 60 minutes. The power interruptions also stress the nickel anodes and worsen the degradation rate. A protective voltage can prevent this, but will reduce the overall efficiency.

Today the capital costs for alkaline electrolyzers lie between 800 and 1300 €/kW_{(Installed)}. The high price for AEC plants is reflected in the price per kilogram hydrogen and thus is far more expensive than conventionally produced hydrogen. The biggest demand for hydrogen comes from chemistry and oil companies, which will not be able to spend up to double the price for green hydrogen. As a solution for a day/night cycle storage the AEC is not ideal since its flexibility is low and start-up times are high.

Today, about 5% of the hydrogen is produced via electrolysis, however, typically as a by-product of chlorine and caustic soda production. Most of the produced hydrogen is used at its production site upon its production. Only a smaller portion is stored for applications, because storing of hydrogen is rather complex. For example, for the grid scale storage of energy over several month large, safe and cheap storage vessels are required. Conventionally, hydrogen is either stored under pressure up to 600 bar, at −252.8° C. as a liquid or in physically or chemically bound form (Q. Lai, M. Paskevicius, D. A. Sheppard, C. E. Buckley, A. W. Thornton, M. R. Hill, Q. Gu, J. Mao, Z. Huang, H. K. Liu, Z. Guo, A. Banerjee, S. Chakraborty, R. Ahuja, K-F. Aguey-Zinsou, ChemSusChem 2016, 8, 2789-2825). To achieve a safe storage, these technologies are all confronted with different challenges. While the storage under pressure does not require additional energy consuming cooling steps, a highly pressure resistant tank is required, which limits the maximum capacity per container. That issue is not to be underestimated, as gaseous hydrogen has an energy density of only 3 kWh/m³ at 1 bar to 530 kWh/m³ at 200 bar. In comparison, diesel has 9912 kWh/m³. Liquid hydrogen reaches an energy density up to 2350 kW/m³, but extensive isolation and additional cooling is required to keep the temperature below −252° C. The storage of unbound hydrogen suffers from loss of hydrogen due to fast diffusion, which may even become a serious safety issue. A different approach is the storage of hydrogen in a physical, physicochemical or chemical bound manner. Bound hydrogen was first observed by its physisorption to palladium in 1868. Other technically feasible options are boro- or aluminium-hydrides, MOFs or porous carbons. However, these materials are expensive, difficult to handle due to reactivity or toxicity. Thus, all of these storage options require at least change of pressure, temperature or light to prepare hydrogen for storage and/or release hydrogen.

In general, the set-up for coventional electrolyzers differs significantly from that of redox flow batteries due to distinct technical requirements. For example, in alkaline electrolysis mainly nickel or nickel-plated steel are used as electrode materials, which are stable in alkaline conditions under electrolytic conditions. In contrast, organic redox flow batteries often employ carbon-based electrodes due to their high electrical conductivity and surface area. As separation materials in electrolyzers mostly ceramic materials are employed, because they are alkali-resistant, gas-impermeable, and pressure-resistance. In contrast, in redox flow batteries polymeric membranes are used due to their low electrical resistance. Accordingly, the components of electrolyzers and redox flow batteries differ, especially in their respective chemistry, due to the different technical requirements of the setups.

Satola et al. (Journal of The Electrochemical Society, 165 (5) A963-A969 (2018)) demonstrate the general challenge of carbon electrode corrosion of a redox flow battery during overcharging mode of the battery. Yi et al. (ChemElectroChem, 2 (2015), pp. 1929-1937) demonstrates the general incompatibility of carbon-based electrode materials with the oxygen evolution reaction (OER) during electrolysis, due to corrosion of carbon to carbon(di)oxide. The authors state that the problem of corrosion is especially crucial for high surface carbons as they are employed in common redox flow batteries to maximize the achievable current-density of electrodes and in the publication the corrosion of carbon nanotubes during OER is demonstrated. In a subsequent publication (Yi et al. Catalysis Today, Volume 295, 2017, pages 32-40) the issue of corrosion of carbon based materials during OER is expanded to glassy carbon as substrate.

In view of the above, it is the object of the present invention to provide a method for hydrogen production, allowing the produced hydrogen to be made available as an energy storage source, e.g. in view of daily as well as seasonal fluctuations in energy production, e.g. of renewable energies. It is also an object of the present invention to provide an electrode for a redox flow battery with superior performance in hydrogen production (and in the redox flow charging/discharging mode after hydrogen production) as compared to conventional electrodes of redox flow batteries. Accordingly, it is also an object of the present invention to provide a redox flow battery allowing optimal performance in both modes, i.e. in the conventional redox flow charging/discharging mode as well as in hydrogen production overcharging mode. It is also an object of the present invention to provide an electrode for a redox flow battery and a redox flow battery with longer lifetime (and increased stability/integrity) when operated in both modes, i.e. in the conventional redox flow charging/discharging mode as well as in hydrogen production overcharging mode.

This object is achieved by means of the subject-matter set out below and in the appended claims.

Although the present invention is described in detail below, it is to be understood that this invention is not limited to the particular methodologies, protocols and reagents described herein as these may vary. It is also to be understood that the terminology used herein is not intended to limit the scope of the present invention which will be limited only by the appended claims. Unless defined otherwise, all technical and scientific terms used herein have the same meanings as commonly understood by one of ordinary skill in the art.

In the following, the elements of the present invention will be described. These elements are listed with specific embodiments, however, it should be understood that they may be combined in any manner and in any number to create additional embodiments. The variously described examples and preferred embodiments should not be construed to limit the present invention to only the explicitly described embodiments. This description should be understood to support and encompass embodiments which combine the explicitly described embodiments with any number of the disclosed and/or preferred elements. Furthermore, any permutations and combinations of all described elements in this application should be considered disclosed by the description of the present application unless the context indicates otherwise.

Throughout this specification and the claims which follow, unless the context requires otherwise, the term “comprise”, and variations such as “comprises” and “comprising”, will be understood to imply the inclusion of a stated member, integer or step but not the exclusion of any other non-stated member, integer or step. The term “consist of” is a particular embodiment of the term “comprise”, wherein any other non-stated member, integer or step is excluded. In the context of the present invention, the term “comprise” encompasses the term “consist of”. The term “comprising” thus encompasses “including” as well as “consisting” e.g., a composition “comprising” X may consist exclusively of X or may include something additional e.g., X+Y.

The terms “a” and “an” and “the” and similar reference used in the context of describing the invention (especially in the context of the claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. No language in the specification should be construed as indicating any non-claimed element essential to the practice of the invention.

The terms “substantially” and “essentially” do not exclude “completely” e.g., a composition which is “substantially free” from Y may be completely free from Y. Where necessary, the word “substantially” or “essentially” may be omitted from the definition of the invention.

The terms “about” or “almost” in relation to a numerical value x means x ±10%.

In a first aspect, the present invention provides an electrode for a redox flow battery comprising:
a substrate, and
a coating applied to a surface of the substrate,
   wherein the coating comprises a conductive carbon material, a (semi-)conductive polymer and, optionallyan oxygen evolution reaction (OER) catalyst.

The present inventors surprisingly found that such a carbon-based electrode exhibiting superior stability towards corrosion by oxygen. Moreover, the appended examples demonstrate that an aqueous flow battery system comprising such an electrode as positive electrode can be overcharged, thereby producing hydrogen gas, which can be used as a seasonal energy storage material after complete charge of the aqueous electrolytes. A flow battery system with the electrode according to the present invention is able to switch reversibly between regular flow battery mode and electrolyzer mode and, thus, can combine the function of a flow battery and an electrolyzer in a single device. Therefore, the invention solves the problem to combine short-term and long-term energy storage of renewable energies in a single device by controlled generation of hydrogen in a flow battery set-up that can reversibly switch between hydrogen generation mode and regular charge/discharge mode.

In one embodiment, the coating comprises a conductive carbon material, a (semi-) conductive polymer an an oxygen evolution reaction (OER) catalyst.

In some embodiments, the conductive carbon material is selected from graphite, carbon felt, carbon fiber, thermal and acid treated graphite, carbon-polymer composite materials, carbon nanotubes, carbon black, graphene, Ir-modified carbon felt and graphene-oxide nanoplatelets. Preferably, the conductive carbon material is selected from carbon nanotubes, graphite, carbon black and graphene. More preferably, the conductive carbon material is carbon nanotubes (CNTs), such as multiwal led carbon nanotubes. The carbon nanotubes are preferably unmodified carbon nanotubes or chemically or physically modified carbon nanotubes, more preferably chemically modified carbon nanotubes other than sulfonated carbon nanotubes. Modified carbon nanotubes may be surface modified, e.g. by linking a chemical group to the surface or by forming an adsorption layer on their surface (e.g. by using anionic or cationic polyelectrolytes). They may chemically treated with excess oxygen to produce oCNTs or with acid groups to produce acid group (e.g. carboxylic acid) modified carbon nanotubes. Accordingly; CNTs may be modified e.g. by wet chemical treatment or by gas treatment.

In some embodiments, the (semi-)conductive polymer may act as an “adhesive” between the substrate and the active layer (coating). Accordingly, the (semi-)conductive polymer may have adhesive properties, in particular with regard to the substrate and the active layer (coating). Preferably, the (semi-)conductive polymer is as little insulating as possible. Examples of the (semi-)conductive polymer include, but are not limited to, polyaniline, polyacetylene, polyphenylene vinylene, polypyrrole, polythiopene, poly(3,4-ethylenedioxythiophene), polyphenylene sulfide and mixtures thereof. Preferably, the (semi-)conductive polymer is polyaniline. Alternatively, the (semi-) conductive polymer is selected from polyacetylene, polyphenylene vinylene, polypyrrole, polythiopene, poly(3,4-ethylenedioxythiophene), polyphenylene sulfide and mixtures thereof. The oxygen evolution reaction (OER) catalyst is usually a metal powder, typically a metallic metal powder. In some embodiments, the OER catalyst is selected from Ru, Ir, Pd, Pt, Au, Ni, Fe, Os, Co, Mn, Zn and their alloys, oxides, respective mixed oxides and perovskites. Also, the OER catalyst may be selected from metallic Ru, Ir, Pd, Pt, Au, Ni, Fe, Os, Co, Mn, Zn and their alloys or may be selected from metallic Ru, Ir, Pd, Pt, Au, Fe, Os, Co, Mn, Zn and their alloys. Preferably, the OER catalyst is not a metal salt, in particular not a Ni salt or an Fe transition complex, such as hexa cyano ferrate, or a combination of a Ni salt and a Fe transition complex, such as hexacyanoferrate.

Preferably, the OER catalyst is a metal, preferably nickel on silica/alumina.

In some embodiments, the (semi-)conductive polymer is polyaniline, the OER catalyst is nickel on silica/alumina and the conductive carbon material is selected from carbon nanotubes, graphite, carbon black and graphene, such as (multiwalled) carbon nanotubes.

In general, the coating of the electrode may comprise further components in addition to the conductive carbon material, the (semi-)conductive polymer and the oxygen evolution reaction (OER) catalyst. Preferably, the coating of the electrode does not comprise further components in addition to the conductive carbon material, the (semi-)conductive polymer and the oxygen evolution reaction (OER) catalyst. Accordingly, the coating may consist of the conductive carbon material, the (semi-)conductive polymer and the oxygen evolution reaction (OER) catalyst.

In some embodiments, the weight ratio of the OER catalyst, the carbon material and the (semi-) conductive polymer in the coating is 50 (OER catalyst): 10 (carbon material): 40 (polymer) to 80:4:16. Preferably, the weight ratio of the OER catalyst, the carbon material and the (semi-)conductive polymer in the coating is 60 (OER catalyst): 8 (carbon material): 32 (polymer) to 80:4:16. More preferably, the weight ratio of the OER catalyst, the carbon material and the (semi-)conductive polymer in the coating is 70 (OER catalyst): 6 (carbon material): 24 (polymer) to 75:5:20; such as about 73:5:22.

The substrate of the electrode is usually carbon-based. The substrate may be carbon-based, such as a substrate comprising graphite and, optionally, polypropylene. For a substrate comprising graphite and polypropylene the weight ratio may be between 60:40 and 95:5 (graphite:polypropylene), preferably between 70:30 and 90:10, more preferably between 75:25 and 85:15; e.g. the substrate may be a mixture of about 80% graphite and about 20% polypropylene. Alternatively, for example, metal electrodes or metal plates coated with a carbon-based active layer may be used as substrate. Non-limiting examples of metal electrodes include nickel, copper and bronze electrodes. Alternatively, coated stainless steel may be used.

The electrode may be of any shape, but a rectangular shape is preferred (e.g. about 4 cm×about 4.2 cm), while the electrode is usually rather thin (e.g., less than 5 mm thickness, preferably less than 4 mm thickness, more preferably less than 3 mm thickness, e.g. less than 2.5 mm thickness). Therefore, it is usually referred to the “two” sides of the electrode, because its thickness is not considered. Accordingly, the “two sides” of the electrode are those sides with the largest dimensions. The coating may be applied to the entire electrode, to each of the two sides (with the largest dimensions) only, or, preferably, only to one side (of those with the largest dimensions) of the electrode. Accordingly, the electrode comprises the inventive coating at least on one side (of those electrode sides with the largest dimensions).

In general, the skilled person is aware of different ways to apply the coating to the (surface of) the electrode substrate. For example, the coating may be pressed onto the substrate (compound material of the electrodes) in two steps. In a first step, the coating may be provided in form of a powder and said powder may be pressed onto the substrate (base electrode), e.g. by applying about 5 metric tons for, e.g., about 10 seconds at, e.g., about 120° C. After the first pressing, excess coating may be removed (e.g., blown off with compressed air). Subsequently, a micro/macro embossing may be pressed onto the side with the coating material. The structure of the electrode surface may be achieved by applying, e.g., about 4 metric tons for, e.g., about 10 seconds at, e.g., about 120° C. The employed embossing may be applied in the center of the electrodes (e.g., on a 2.3 cm×1.9 cm area), and it may feature coinages (such as about 24 large coinages having a height of about 1.4 mm—e.g., arranged in four rows next to each other—and/or about 255 small coinages having a height of about 0.33 mm around those).

In a further aspect, the present invention also provides an aqueous redox-flow battery (RFB) comprising the electrode according to the present invention as described above.

Redox-flow batteries are known in the art and usually comprise an electrochemical cell having a first compartment containing a positive electrolyte (also referred to as “posolyte” or “catholyte”) with an electrode at least partially immersed in the positive electrolyte solution, and a second compartment containing a negative electrolyte (also referred to as “negolyte” or “anolyte”) with an electrode at least partially immersed in the negative electrolyte solution. A separator (e.g., a semi-permeable membrane) usually separates the first and second compartments. The separator may be an electrolyte-filled gap or a selective membrane, such as an ion-exchange membrane, which does not allow the electrolyte to migrate from the first compartment to the second compartment and vice versa. In addition, an RFB may comprise storage tanks for storing of the positive and negative electrolyte solutions, respectively, in particular at oxidized or reduced charge states; and pumps to pump the positive and negative electrolyte solutions from the storage tanks to the compartments and from the compartments to the storage tanks. In addition, a redox-flow battery may comprise a source and inlet of inert gas to deoxygenate the system and to stabilize the charged electrolytes.

In RFBs, the energy is stored by positive and negative electrolyte solutions (anolyte or catholyte solution, respectively), which circulate (in separate circuits) between a storage tank and the electrochemical cell. Each of the positive and negative electrolyte solutions contain a redox couple. The redox species is configured to accept (reduction, cathode) and donate (oxidation, anode) electrons during the charging process and, inversely, to donate (oxidation, cathode) or accept (reduction, anode) electrons during the discharging process. The separator, such as an ion-exchange membrane, separates the two chambers of the electrochemical cell and ensures to close the electrical circuit between the positive and negative electrolyte solutions, (except for the external electrical current circuity). In the discharge mode, the negative electrolyte reacts at the electrode to generate electrons, which are passed to the external electrical current circuit. The charge-carrying species are transported to the separator such that ion exchange occurs across the separator.

Accordingly, the RFB (or a cell thereof) preferably comprises a positive electrode, a positive electrolyte solution, a negative electrode, a negative electrolyte solution, and a separator, such as an ion-exchange membrane (which separates the positive from the negative electrolyte solution. Preferably, the positive electrode of the RFB is the electrode according to the present invention as described above. While the above-described electrode may also be used as negative electrode, any (standard) RFB electrode (e.g., a carbon electrode with standard carbon coating, such as Cabot Carbon PBX135) may be used as negative electrode.

The RFB may comprise a stack of individual cells, and individual cells can be arranged in series to increase the overall stack voltage. Stacks may be arranged in a bipolar manner such that current flows in series from one cell to the next.

Depending on the solvents employed for the electrolyte solution, redox flow batteries can be classified as “aqueous” and “non-aqueous”. Aqueous RFBs employ aqueous solvents, such as water or mixtures of water and water-miscible solvents for forming the electrolyte solution. In contrast, predominantly organic solvents may be used as the electrolyte solvents in non-aqueous systems. To produce hydrogen gas by electrolysis of the solvent of the electrolyte solution as described above, the RFB is preferably an aqueous RFB, i.e. an RFB comprising a predominantly aqueous solvent having e.g. a water content of at least 80 or at least 90 or at least 95 wt %, in particular an essentially aqueous solvent of at least 98 wt %, e.g. an fully aqueous solvent of 100 wt % water content. Aqueous RFBs are more convenient to handle and safer than non-aqueous systems. Usually, the operating potential of aqueous RFBs is constrained by the electrochemical potential window of water (generally lower than 2.0 V depending on pH).

In the RFB, any suitable redox species may be employed. The redox species is preferably soluble in a predominantly aqueous solvent, in particular in an essentially aqueous solvent, e.g. in an aqueous solvent. For example, the redox species in both, posolyte and negolyte solution, may be organic. Alternatively, the redox species in both, posolyte and negolyte solution, may be inorganic. In some instances it may be preferred, if the redox species in the posolyte solution are organic and in the negolyte solution inorganic. In other instances, the redox species in the posolyte solution are inorganic and in the negolyte organic. Various anorganic and organic redox species for RFBs are known in the art, e.g. in Weber A. Z., Mench M. M., Meyers J. P., Ross P. N., Gostick J. T. and Liu Q. H. 2011, Redox flow batteries: a review, J Appl Electrochem 41, p. 1137-1164.

While standard RFB technologies are typically based on inorganic metal-based redox active materials only, such as vanadium, the redox-flow battery is preferably an organic redox-flow battery, i.e. an RFB comprising redox active organic molecules as redox active species by at least one of the RFB's half-cells. In case of a fully organic RFB system, two separate solutions of organic redox active species are guided and pumped into each of the half cells from separate tanks. The charge/discharge redox cycle is preferably enabled by porous semi-permeable separating membrane. The catholyte solution can include organic radical materials such as TEMPO, and metal complexes, such as ferrocene, whereas the anolyte solution can include viologenes and quinones. These organic active materials are particularly useful for RFB with aqueous solutions. Further examples of organic redox species for aqueous RFBs are provided in Wedege, K., Dražević, E., Konya, D. et al. Organic Redox Species in Aqueous Flow Batteries: Redox Potentials, Chemical Stability and Solubility. Sci Rep6, 39101 (2016) doi:10.1038/srep39101. Also, the organic redox-active species may be a water-soluble substituted phenazine, e.g. a sulfonated phenazine. Preferably, the substituted phenazine is substituted at at least two carbon atoms of the ring structure, preferably three or four cabon ring atoms, e.g. by sulfonate, hydroxyl or (substituted) amino substituents. In a specific example, 7,8-dihydroxyphenazine-2-sulfonic acid (e.g., about 0.5 M) may be used as negative aqueous electrolyte (negolyte). The other half cell may contain another organic or inorganic redox-active species. It may contain e.g. metal ion (e.g. iron) complexes, such as ferrocyanide. Thus, an aqueous mixture of potassium and sodium ferrocyanide (e.g., about 0.4 to 0.5 M) may be used as positive electrolyte (posolyte).

In some embodiments, the RFB does not contain or does not apply overcharge inhibiting control elements when entering into the overcharging mode. Alternatively, such control elements may be switched off on demand (if present).

In some embodiments, the RFB comprises a hydrogen gas outlet conduit, which may be foreseen for removing the hydrogen gas from the RFB.

In a further aspect, the present invention provides a method for operating a redox-flow battery comprising the following steps:
(1) providing a redox-flow battery comprising an aqueous electrolyte solution;
(2) operating the redox-flow battery in the charging/discharging mode;
(3) overcharging the redox-flow battery, thereby generating hydrogen gas;
(4) terminating overcharging of the redox-flow battery and discharging the redox-flow battery; and
(5) operating the redox-flow battery in the charging/discharging mode.

As described above, the present inventors have found that an RFB can be used for its characteristic conventional electrochemical energy storage and, in addition, as a source for generating hydrogen gas by applying an overcharging mode resulting in water hydrolysis. The combination of electrical energy storage and hydrogen gas production allows for a storage technology supporting any short or long term demand ranging from seconds to several months. The inventive method thus combines the advantages of the RFB, such as high efficiency, fast response and high safety and the advantages of hydrogen production/storage, in a single fully scalable and commercial attractive set-up. The redox-flow battery allows to store electrical energy for addressing short-term fluctuations (over the day cycle). In addition, the RFB overcharging mode can be used for hydrogen production (and subsequent storage) whenever electrical power production exceeds short-term energy demand.

The set-up as a powerful tool for producing hydrogen gas may be applied by interrupting the conventional battery charging/discharging mode by a redox flow battery overcharging mode. The overcharging mode may be started, once the battery has been fully charged. The overcharging mode typically requires the potential of water electrolysis to be exceeded. The overcharging mode may be applied for an extended period of time for producing hydrogen. The inventors surprisingly found that the redox flow battery can be switched from the overcharging mode to its default RFB charging/discharging mode, simply by reverting to the potential of the default charging/discharging mode. Switching from the default charging/discharging to the overcharging mode (and vice versa) may be repeatedly carried out without any damage to the RFB's function. The hydrogen gas may be generated by the negative or by the positive electrode, more typically by thecathode. The produced hydrogen gas may be readily be separated from the aqueous electrolyte solution and collected for storage or other purposes. For the reconversion of the stored energy (in the form of hydrogen gas) to e.g. electrical energy, the hydrogen gas can be used in the same set-up, the hydrogen gas may be transferred to a gas-fired plant or it may be introduced into a conventional fuel cell.

Accordingly, the present invention also provides a method for generating hydrogen gas with a redox-flow battery comprising the following steps:
(1) providing a redox-flow battery comprising an aqueous electrolyte solution;
(2) fully charging the redox-flow battery;
(3) overcharging of the redox-flow battery, once the battery has been fully charged, thereby generating hydrogen gas;
(4) discharging the redox-flow battery; and
(5) optionally, operating the redox-flow battery in the charging/discharging mode.

In the methods of the present invention, any conventional redox-flow batteries (RFBs) based on aqueous electrolyte solutions (also referred to as “aqueous RFB”) may be used. RFBs are known in the art and described, for example, in Weber A. Z., Mench M. M., Meyers J. P., Ross P. N., Gostick J. T. and Liu Q. H. 2011, Redox flow batteries: a review, J Appl Electrochem 41, p. 1137-1164.

In general, any RFB as known in the art (without structural modifications) may be used in the inventive method. For example, no (additional) catalytic beds or other catalytic components are required, because gaseous hydrogen is produced in the RFB cell itself by the method of the present invention, in particular at its negative electrode. Accordingly, the RFB as applied by the inventive method does preferably not comprise additional catalytic beds or components, e.g. for regenerating an electrolyte or for generating hydrogen gas.

Moreover, in general, the electrodes of the RFB may be of any material. However, in aqueous systems, graphitic or vitreous carbon materials are preferred electrode materials. The electrode material of the RFB may be selected from the group consisting of graphite, carbon felt, carbon fiber, thermal and acid treated graphite, carbon-polymer composite materials, carbon nanotubes, Ir-modified carbon felt and graphene-oxide nanoplatelets. Preferably, the electrodes of the redox-flow battery are carbon electrodes.

Preferably, the RFB used in the method according to the present invention is an RFB comprising the electrode according to the present invention as described above. Such RFBs are described above.

Accordingly, the present invention also provides a method for operating the aqueous redox-flow battery according to the present invention as described above, wherein the redox-flow battery is operated in a charging/discharging mode and in electrolyzer mode for production of gaseous hydrogen in an alternating manner. For example, the RFB of the invention may be operated at first in the charging/discharging mode, thereafter in the electrolyzer mode for production of gaseous hydrogen (as described above, e.g. overcharging as described above), and then again in the charging/discharging mode.

In the methods of the present invention, the RFB is typically operated in its default charging/discharging mode. As used herein, the expression “operating the redox-flow battery in the charging/discharging mode” is understood such that the RFB is at least once charged and at least once discharged (i.e. at least one charging/discharging cycle).

In general, it is understood, that it is not required to fully charge or to fully discharge the RFB (e.g., by a charging/discharging cycle). Rather, charging of the RFB may depend on the energy available for storage (e.g. during peak energy production). Likewise, discharging of the RFB may depend on the required energy to be provided by the RFB. In some instances, the RFB may be fully charged and discharged in each cycle. In other instances, the RFB is not fully charged and discharged in each cycle. While “fully charged” usually means that the capacity of the RFB to store electrochemical energy in the redox species of the RFB is fully utilized, i.e. the redox species of the RFB are fully oxidized/reduced (representing the full storage capacity), an RFB may also be considered as “fully charged” when it is charged by at least 80%, preferably at least 85%, more preferably at least 90%, or even more preferably at least 95%.

The RFBs to be employed by the present method do not contain or do not apply overcharge inhibiting control elements when entering into the overcharging mode or such control elements are switched off on demand. RFB used in the methods of the invention can thus be overcharged when desired.

The method of the invention thus allows by its step (3) the RFB to be overcharged, such that hydrogen is produced as described above. As used herein, the term “overcharging” means that charging of the RFB is continued after the battery is fully charged.

In some embodiments, the potential is increased until a desired overcharging potential is reached in step (3). Thereafter, the current flow is continued and the applied voltage is maintained at about the overcharging potential, until the overcharging mode according to step (3) has been terminated. For example, the overcharging potential may be about 2.0, 2.1, 2.2, 2.3, 2.4, 2.5, 2.6, 2.7, 2.8, 2.9 or 3.0 V. In some instances, the overcharging potential is about 2.6 or 2.7 V.

In some embodiments, the positive electrolyte of the redox-flow battery is used in excess. While an excess of the positive electrolyte is not required, it may be advantageous to avoid or reduce the generation of oxygen at the respective counter-electrode when the RFB is overcharged to produce hydrogen, which may avoid or reduce corrosion of the electrode.

The design of an RFB used in the inventive method may differ from the standard RFB design by allowing hydrogen gas (to be produced in step (3)) to exit the RFB's half-cell. Thus, a hydrogen gas outlet conduit is preferably foreseen for removing the hydrogen gas from the RFB. Thus, the hydrogen gas is typically stored separately and not retained within the tanks storing the electrolyte solution.

For example, the hydrogen gas produced in step (3) may be stored in the geological underground, such as in exhausted oil and/or gas deposits, or in salt caverns. Preferably, the hydrogen gas produced in step (3) may be stored in a salt cavern. Such caverns may have a size of 500.000 m 3 or more and/or a working pressure of 200 bar and above. Storage in the geological underground offers the possibility to store hydrogen gas in larger quantities than in diffusion-tight vessels. It is also a more cost-efficient approach than other alternatives known in the art. Salt caverns are an advantageously suitable option for this application, as they have a low proportion of other gases that could impair hydrogen gas charging and discharging within the cavern. In addition, they exhibit low hydrogen leakage.

### BRIEF DESCRIPTION OF THE FIGURES

In the following a brief description of the appended figures will be given. The figures are intended to illustrate the present invention in more detail. However, they are not intended to limit the subject matter of the invention in any way.

FIG. 1 shows for Example 1 the development of voltage (U), current (I) and electric charge (Q) of the exemplified Redox-Flow-Battery for a cycling experiment (a) (cycling between fully charged (1.7 V) and discharged (1.0 V) state; (b) overcharging and hydrogen gas generation; (c) cycling between fully charged (1.7 V) and discharged (1.0 V) state).

FIG. 2 shows for Example 2 the voltage curve of the cycling experiments of electrode A.

FIG. 3 shows for Example 2 the battery cell polarization experiments before (dots) and after (crosses) water electrolysis (grey) and depiction of the respective power densities (black) before (dots) and after (crosses) water electrolysis of electrode A.

FIG. 4 shows for Example 2 the voltage curve of the cycling experiments of electrode B.

FIG. 5 shows for Example 2 the battery cell polarization experiments before (dots) and after (crosses) water electrolysis (grey) and depiction of the respective power densities (black) before (dots) and after (crosses) water electrolysis of electrode B.

FIG. 6 shows for Example 2 the voltage curve of the cycling experiments of electrode C.

FIG. 7 shows for Example 2 the voltage curve of the cycling experiments of electrode D.

FIG. 8 shows for Example 2 the battery cell polarization experiments before (dots) and after (crosses) water electrolysis (grey) and depiction of the respective power densities (black) before (dots) and after (crosses) water electrolysis of electrode D.

### EXAMPLES

### Example 1

### Generation of Hydrogen with an Aqueous Redox-Flow Battery

An organic aqueous redox-flow-battery cell assembly was used. Pressed carbon electrodes served as both, the positive and negative electrode. 7,8-Dihydroxyphenazine-2-sulfonic acid (0.5 M) was used as a redox-active species for the negative aqueous electrolyte (negolyte) solution and an aqueous mixture of potassium and sodium ferrocyanide (0.4 M) was used as redox-active species for the positive electrolyte (posolyte) solution. The posolyte redox-active species was used in slight excess. Electrolyte solutions were pumped by peristaltic pumps (Drifton BT100-1L, Cole Farmer Ismatec MCP and BVP Process IP 65) at a rate of 48 mL/min to the corresponding electrodes, respectively. In the redox-flow cell, the positive and negative electrolyte solutions were separated by a cation exchange membrane (630K, supplier: fumatech). The gap between electrode surface and membrane was 0.5 mm on each side of the cell. According to Faraday's law, a maximum capacity of 536 mAh was achievable by the applied redox-flow battery cell setup.

Prior to each experimental test, the membrane was conditioned in 0.5 M KOH/NaOH (50/50) for at least 150 h. The electrolyte solution reservoir was purged with N₂ gas for 1 h before start of charging. During the experiments the inert atmosphere was maintained.

Electrochemical testing was performed on a BaSyTec (BaSyTec GmbH, 89176 Asselfingen, Germany) battery test system. The redox-flow battery cell was cyclized between 1.0 and 1.7 V at 10 mA/cm². For cycling, the cell was charged at a current density of 10 mA/cm² up to 1.7 V (fully charged) and discharged at the same current density down to a 1.0 V cut-off. In some tests, at least one further cycle of charging/discharging (between 1.0 and 1.7 V) was performed.

Before generating hydrogen gas, the cell was fully charged (to 1.7 V). Once an applied voltage of 1.7 V had been reached, charging was continued until the current dropped below 1.5 mA/cm² (full charging of the limiting negative electrolyte). The overcharging potential was then set to 2.7 V and the current flow (charging) was continued at 10 mA/cm² to the overcharging voltage of 2.7 V. The potential rose, as the excess of the posolyte was used for oxidation while on the negative electrode hydrogen gas started being produced. Accordingly, hydrogen gas formation was observed at the negative electrode. At about 2.6 V, the ferrocyanide redox-active species was observed to be oxidized to ferricyanide. A plateau was reached, where the voltage remained essentially constant at a current density of 10 mA/cm². Hydrogen gas was observed to be continuously produced.

After about 17 h (about 1280 mAh) of overcharging and thus producing hydrogen gas, the overcharging mode was manually terminated, followed by battery cell discharging to 1.0 V. Thereafter, cycling of the battery cell (charging/discharging mode) between 1.0 to 1.7 V as described above was carried out. It was found that the redox-flow battery was—without any loss of function—again usable (in the in the redox-flow battery charging/discharging mode for default battery cell cycling) after being operated for an extended period of time in the overcharging operation mode for hydrogen gas production. Thus, the redox flow battery may be switch from its default cell cycling mode to the overcharging operation mode and again back to the default cell cycling mode.

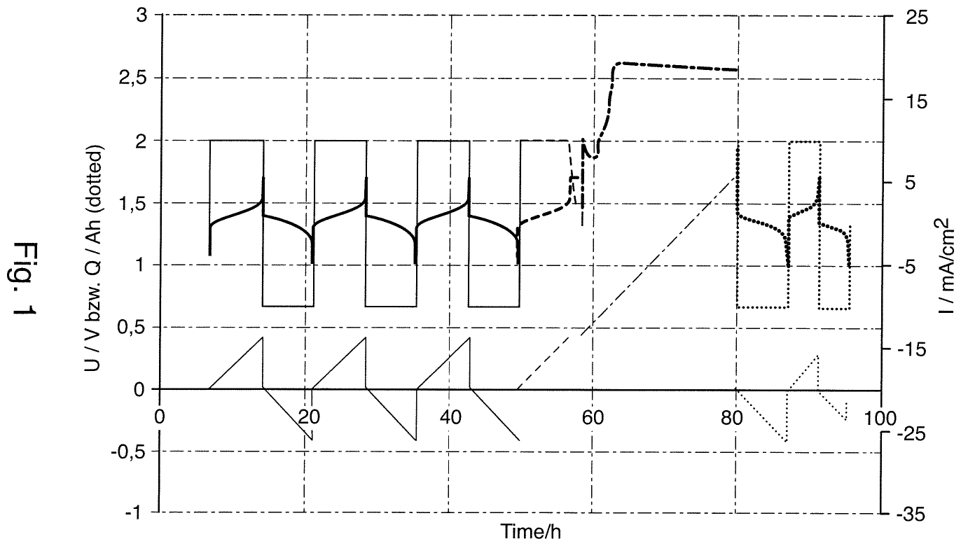

FIG. 1 shows the voltage (U), current (I) and electric charge (Q) of the exemplified Redox-Flow-Battery as a function of time in the course of the experiment described above (a) (cycling between fully charged (1.7 V) and discharged (1.0 V) state; (b) overcharging and hydrogen gas generation; (c) cycling between fully charged (1.7 V) and discharged (1.0 V) state).

The produced hydrogen was collected. It was calculated that about 1 Ah allowed to produce approx. 0.42 l of hydrogen gas. At the plateau of 2.6 V, 4.8 Wh were required per liter hydrogen gas. This corresponds to 48% electrical energy efficiency. Further details are provided in Table 1 below:

TABLE 1
Example Redox-Flow-Battery Hydrogen production:

| | | |
|---|---|---|
| Battery power | 500.000 | kW |
| | 500 | MW |
| Battery storage duration | 6 | h |
| Battery capacity | 3.000.000 | kWh |
| | 3.000 | MWh |
| Hydrogen production capability | 80.769.231 | L/h |
| | 80.769 | m³/h |
| | 6.793 | t/h |
| Heat value | 2,995 | kWh/m³ |
| Heat value production | 241.904 | kWh/h |

| | |
|---|---|
| Efficiency | 48% |

The applied Redox-Flow-Battery according to Example 1 is able to store 3.000 MWh of electrical energy, e.g. adapted for balancing daily fluctuations (representing short term energy storage).

The hydrogen gas may be stored in a salt cavern. In combination with salt cavern storage, the Redox-Flow-Battery of the present Example is able to store 172 GWh of hydrogen gas for balancing seasonal fluctuations (representing long term energy storage). The storage would be sufficient for 714 hours or 30 days of hydrogen production. Details of an exemplified salt cavern, e.g. for storage of hydrogen produced by the (exemplified) Redox-Flow-Battery, are provided below in Table 2:

TABLE 2
Exemplified salt-cavern:

| Cavern Volume | 500.000 | m³ |
|---|---|---|
| Position below underground | 1000 | m |
| Max pressure | 180 | bar |
| Min pressure | 60 | bar |
| Utilizable hydrogen | 4.850 | T |
| Leakage | 0.0015% | |
| Hydrogen Gas Storage duration | 714 | h |
| | 30 | d |
| Energy capacity | 172.175.000 | kWh |
| | 172 | GWh |

### Example 2

### Comparison of Differently Coated Electrodes

Next, redox flow batteries (RFBs) with differently coated electrodes were tested (i) in conventional cycling and polarization of the RFB; and (ii) in hydrogen production.

### General Cell Test Setup:

In all experiments 25 ml of 7,8-Dihydroxyphenazine-2-sulfonic acid (0.5 M) was used as a redox-active species for the negative aqueous electrolyte (negolyte) solution and 45 ml of an aqueous mixture of potassium and sodium ferrocyanide (0.467M) was used as redox-active species for the positive electrolyte (posolyte) solution. Electrolyte solutions were pumped by peristaltic pumps (Drifton BT100-1L, Cole Parmer Ismatec MCP and BVP Process IP 65) at a rate of 72 mL/min to the corresponding electrodes, respectively. In the redox-flow cell, the positive and negative electrolyte solutions were separated by a cation exchange membrane (e.g.: 620PE from fumatech). The gap between electrode surface and membrane was 1.5 mm on each side of the cell.

Prior to each experimental test, the membrane was conditioned in 0.5 M KOH/NaOH (50/50) for at least 72 h. The electrolyte solution reservoir was purged with N2 gas for 1 h before start of charging. During the experiments, the inert gas atmosphere was maintained at a pressure of 30 to 40 mbar.

Electrochemical testing was performed on a Biologic battery test system. The redox-flow battery cell was cyclized between 1.0 and 1.6 V at 20 mA/cm². For cycling, the cell was charged at a current density of 20 mA/cm² up to 1.6 V (fully charged) and discharged at the same current density down to a 1.0 V cut-off.

### Cycling Experiments

In all tests prior to the hydrogen evolution, the batteries were cycled and polarized to obtain a reference cycle and polarization of the battery. After polarization, the hydrogen production was performed followed by a full cycle and a polarization. For comparison, the battery was cycled again after the polarization. Accordingly, the following test plan was used:
1. Galvanostatic charging of the battery and holding U as it reached the potential of 1.6 V until the battery's current I was below 9 mA;
2. Galvanostatic discharging of the battery and holding U as it reached the potential of 1.0 V until the battery's current I was above minus 9 mA;
3. Repeating step 1;
4. Polarization of the battery: testing the battery's characteristics while discharging with increasing currents every 30 seconds;
5. Repeating step 1 to compensate lost charge during the polarization;
6. Hydrogen production: continuing to charge the battery over its capacity with 13.33 mA/cm² for 5 hours, with a cut off potential of 5 V. The lower current was chosen to keep the overall power of the system under the highest possible power of 0.4 W/cm² (a normal cyclization has a power of 0.18 W/cm²);
7. After the hydrogen production, the battery was paused for 1 hour before the battery was discharged again (without holding the potential at 1 V);
8. Repeating step 1;
9. Polarization; and
10. Full cycle of charging and discharging according to steps 1 and 2.

In order to measure and prove the hydrogen evolution, a hydrogen sensor was attached to the gas outlet of the negolyte. In all experiments the sensor measured hydrogen. In some experiments the hydrogen was collected to calculate the efficiency of the hydrogen production. To confirm the tightness of the membrane, a hydrogen sensor was also attached to the gas outlet of the posolyte. In none of the experiments hydrogen was measured on the posolyte's gas outlet.

### Electrodes Tested

The compound material for all electrodes was made of a mixture of 80% graphite and 20 polypropylene, while the coatings of the positive electrodes varied. The coatings were pressed onto the compound material of the electrodes in two steps. In a first step, the coating powders were pressed onto the base electrode by applying 5 metric tons for 10 seconds at 120° C. After the first pressing, excess coating was blown off with compressed air and the electrode had its shape of a 4 cm×4.2 cm rectangle. Subsequently, a micro/macro embossing was pressed onto the side with the coating material. The structure of the electrode surface was achieved by applying 4 metric tons for 10 seconds at 120° C. The employed embossing was applied in the center of the electrodes on a 2.3 cm×1.9 cm area and features 24 large coinages with a height of 1.4 mm—arranged in 4 rows next to each other—and 255 small coinages with a height of 0.33 mm around those. For all tests, the negative electrode was a conventional electrode with standard coating (200 mg Cabot Carbon PBX135). Table 3 shows the different coatings used for the positive electrodes:

TABLE 3
Active layer composition of electrodes employed as
positive electrodes in the electrochemical set-up.

| Electrode | Description | Material of the electrode active layers | | |
|---|---|---|---|---|
| A | Carbon only | Multiwalled Carbon Nano | 200 | mg |
| | | Tubes | | |
| B | Carbon + polymer | Polyaniline | 130 | mg |
| | | Multiwalled Carbon Nano | 70 | mg |
| | | Tubes | | |
| C | OER catalyst only | Nickel on Silica/Alumina | 400 | mg |
| | | (65% wt.) | | |
| D | Carbon + polymer + | Nickel on Silica/Alumina | 270 | mg |
| | OER catalyst | Polyaniline | 80 | mg |
| | | Multiwalled Carbon Nano | 20 | mg |
| | | Tubes | | |

### Electrode Evaluation—Electrode A

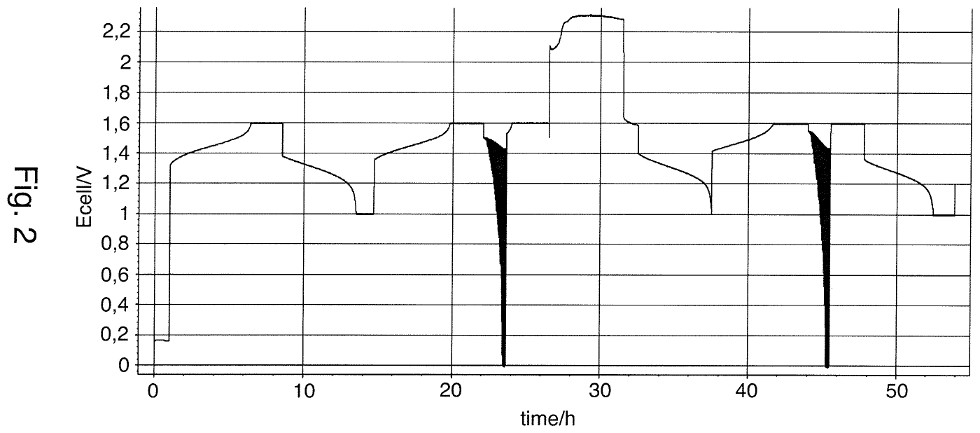

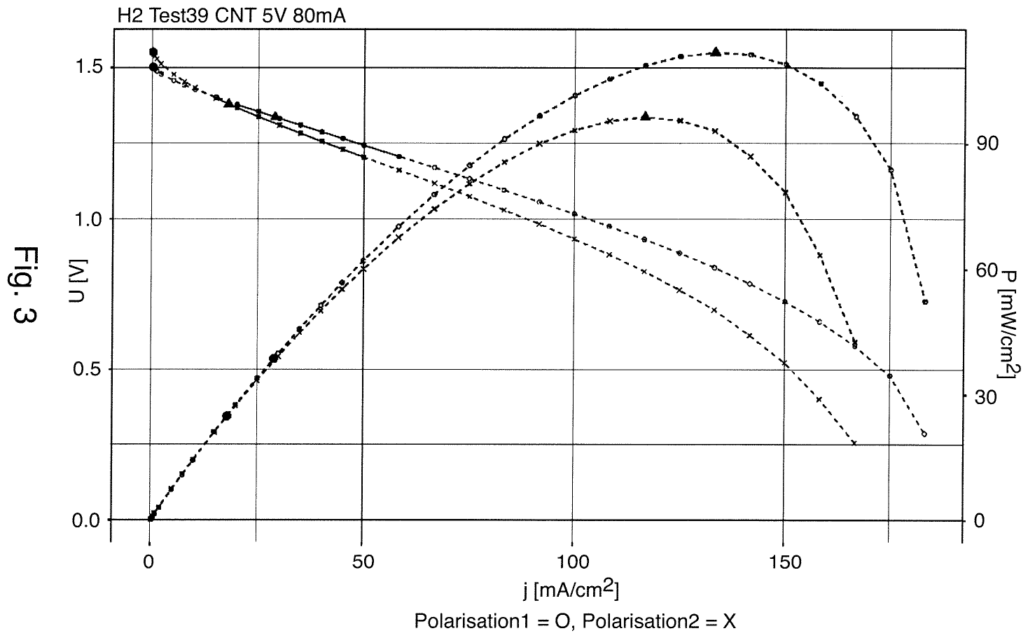

Electrode A was coated with a conductive carbon material, namely, multiwalled carbon nano tubes (CNT). The overcharging potential of electrode A reached a plateau at 2.3 V. The evaluation of the polarization shows an increase of the ohmic resistance from 4.469 Ω/cm² to 5.569 Ω/cm², as well as a maximum power density decrease from 111.886 mW/cm² to 96.478 mW/cm² (86.23% of the initial power). Hence, the battery could not charge and discharge with the entire initial performance. After the experiment, a swelling and disintegration of the active coating was observed. The respective data are depicted in FIG. 2 and FIG. 3.

### Electrode Evaluation—Electrode B

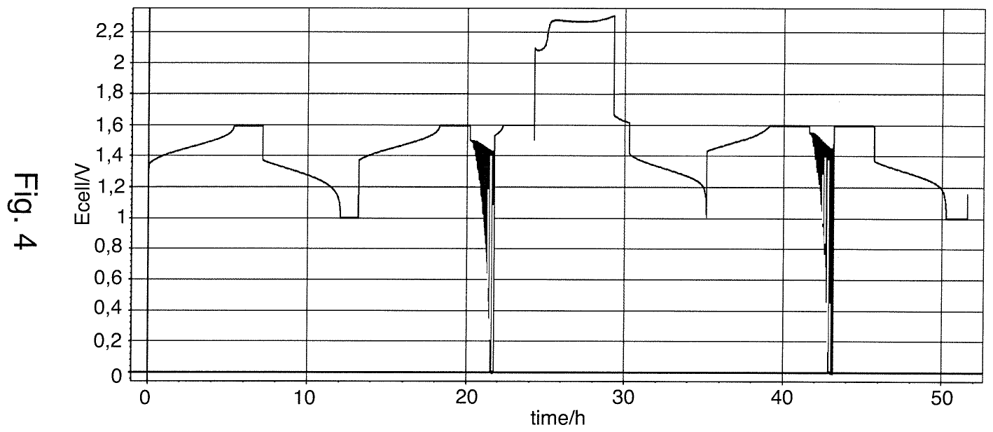

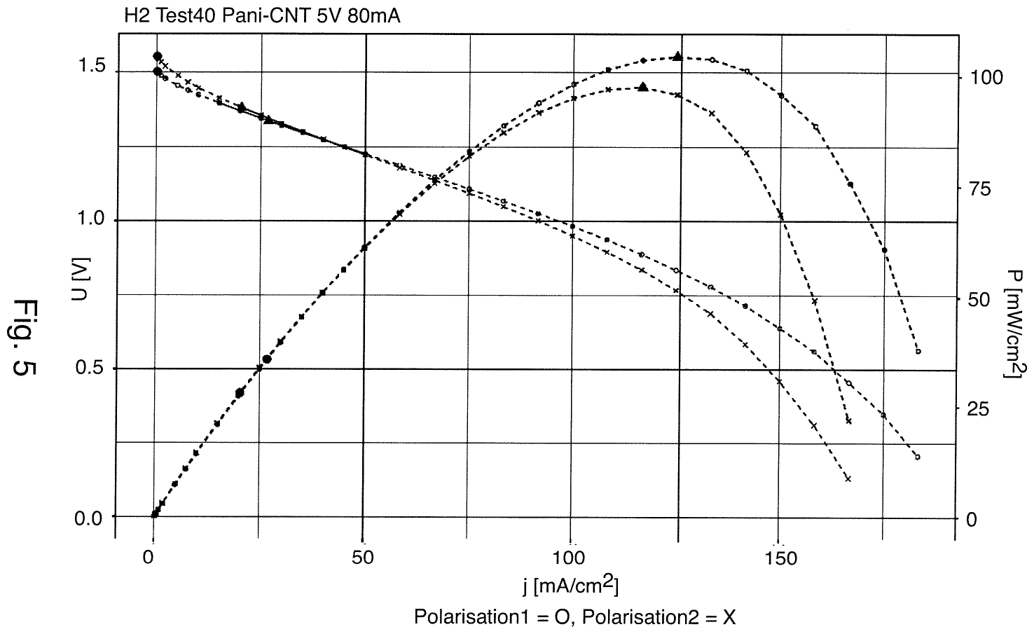

To prevent the swelling and subsequent detachment of the active coating observed with electrode A, conductive polymers (e.g. polyaniline emerald salt) were identified as additives for the carbon nano tubes and the base coating which was used in electrode B. A similar plateau at just under 2.3 V was reached while overcharging. While the evaluation of the polarizations showed a slightly lower initial power and higher ohmic resistance, the power loss was 7.21% lower than with a pure CNT coating (electrode A) as the initial maximum power decreased from 104.449 mW/cm² to 97.597 mW/cm² resulting in 93.44% of the initial power. The ohmic resistance increased from 4.883 Ω/cm² to 5.374 Ω/cm². The respective data are shown in FIG. 4 and FIG. 5.

### Electrode Evaluation—Electrode C

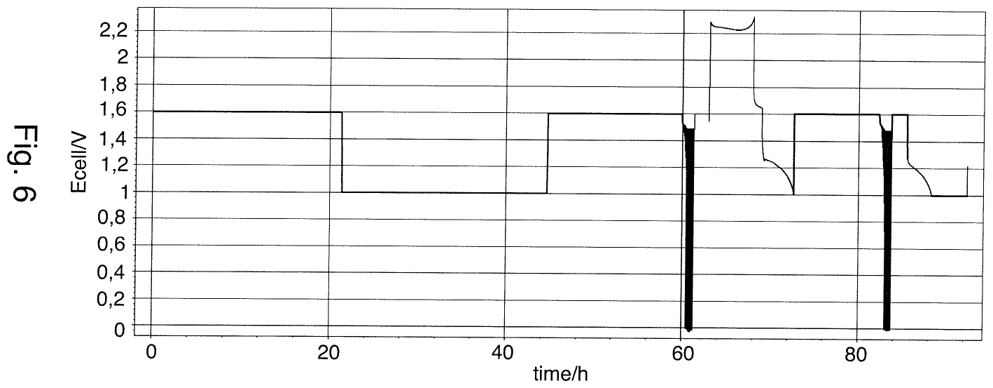

To get hold of the electrode corrosion due to oxygen evolution during electrolysis, OER-catalyst materials were used as coatings for the positive electrode C. However, the selected OER catalyst (silica/alumina supported nickel) did not show sufficient activity in the initial regular flow battery mode. To fully charge the battery took 21 hours, which is more than double of a “normal” RFB charging process with standard electrodes. The polarization resulted in a maximum power of 35.5938 mW/cm² and an ohmic resistance of 10.7 Ω/cm². Surprisingly, the maximum power increased to 42.6744 mW/cm² and the resistance decreased to 9.8 Ω/cm² after the electrolysis of water. However, the coating resulted in an overall low performance for a flow battery. The data for electrode C are shown in FIG. 6.

### Electrode Evaluation—Electrode D

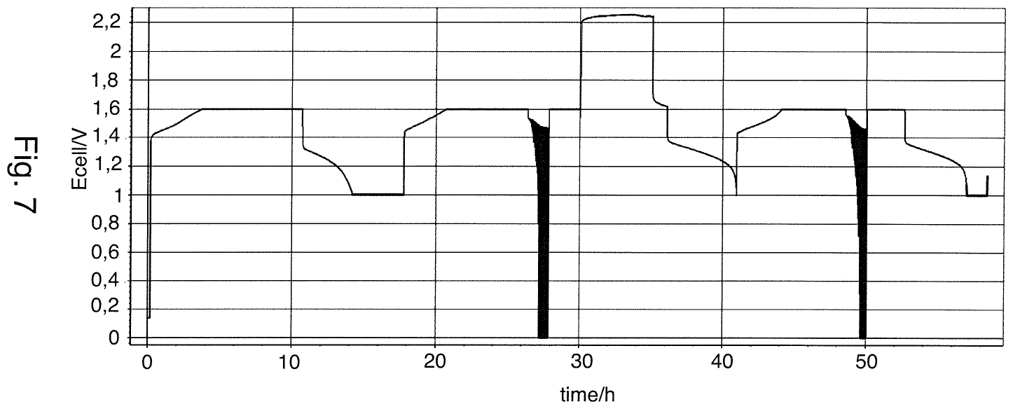

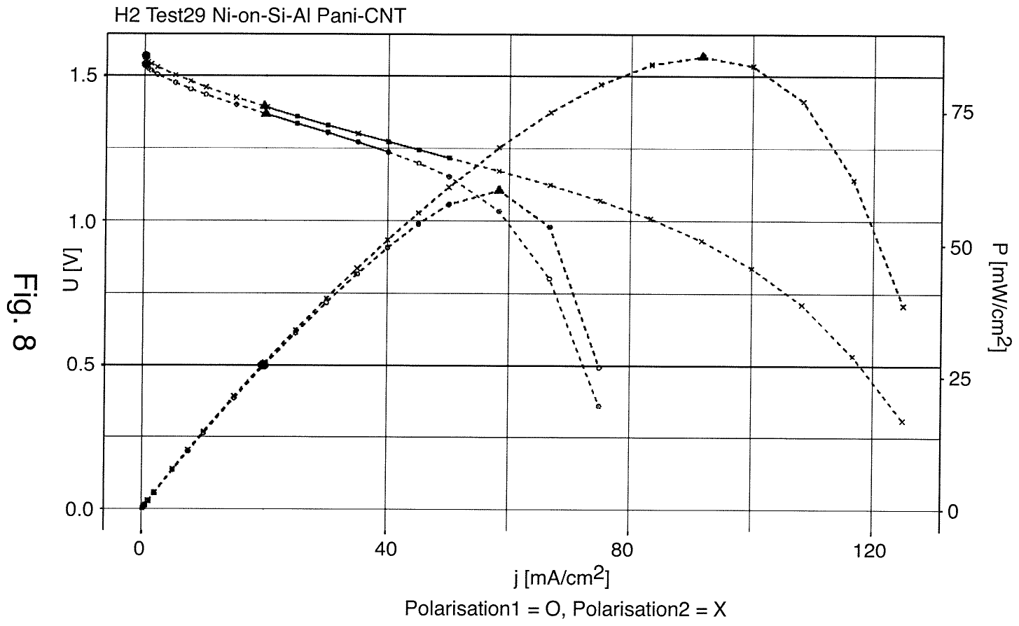

For electrode C, the small surface of metal coatings compared to carbon coating is problematic for a redox flow battery and results in little to no chemical activity with the electrolyte during the regular flow battery mode. Another challenge is to firmly adhere and combine the metal powder (OER catalyst) with the conductive carbon material and with the compound of the electrode. These problems were solved with electrode D comprising a coating of an OER catalyst (nickel on silica/alumina powder), a polymer (polyaniline) as binding material and a conductive carbon material (multiwalled carbon nano tubes). With electrode D a stable overcharging potential at 2.25 V was hold for the 5 hours of hydrogen production. The polarization shows a rather low initial performance of the electrode compared to electrode A. After hydrogen production, however, the performance improved. The evaluation of the polarization shows a decrease of the ohmic resistance from 6.527 Ω/cm² to 5.803 Ω/cm², and a maximum power density increase from 60.271 mW/cm² to 85.433 mW/cm². Therefore, the power density increased 141.75% after the water electrolysis. A test without overcharging showed that normal cyclization does not result in a comparable effect. The production of hydrogen with this kind of electrode improves the functionality of the electrode. The data are shown in FIG. 7 and FIG. 8.

Table 4 shows a summary of electrode performances:

TABLE 4
Key performance indicators for the employed electrodes
in the set-up before and after electrolysis of water.

| | Polarisation before Electrolysis | | | | Polarisation after electrolysis | | |
|---|---|---|---|---|---|---|---|
| | Maximum | | Ohmic resistance | | Maximum Power | Ohmic resistance | |
| Electrode | Power density | | per cm² | | density | per cm² | |
| A | 111.886 | mW/cm² | 4.469 | Ω/cm² | 96.478 mW/cm² | 5.569 | Ω/cm² |
| B | 104.449 | mW/cm² | 4.883 | Ω/cm² | 97.597 mW/cm² | 5.374 | Ω/cm² |
| C | 35.5938 | mW/cm² | 10.7 | Ω/cm² | 42.6744 mW/cm² | 9.8 | Ω/cm² |
| D | 60.271 | mW/cm² | 6.527 | Ω/cm² | 85.433 mW/cm² | 5.803 | Ω/cm² |

1. An electrode for a redox flow battery comprising:
a substrate, and
a coating applied to a surface of the substrate,
wherein the coating comprises a conductive carbon material, a (semi-)conductive polymer and, optionally, an oxygen evolution reaction (OER) catalyst.

2. The electrode according to claim 1, wherein the coating comprises a conductive carbon material, a (semi-)conductive polymer and an oxygen evolution reaction (OER) catalyst.

3. The electrode according to claim 1, wherein the conductive carbon material is selected from graphite, carbon felt, carbon fiber, thermal and acid treated graphite, carbon-polymer composite materials, carbon nanotubes, carbon black, graphene, Ir-modified carbon felt and graphene-oxide nanoplatelets.

4. The electrode according to claim 1, wherein the conductive carbon material is carbon nanotubes.

5. The electrode according to claim 4, wherein the carbon nanotubes are unmodified carbon nanotubes or chemically or physically modified carbon nanotubes other than sulfonated carbon nanotubes.

6. The electrode according to claim 5, wherein the carbon nanotubes are surface modified by an adsorption layer or by chemical modification of their surface.

7. The electrode according to claim 1, wherein the (semi-) conductive polymer is selected from polyaniline, polyacetylene, polyphenylene vinylene, polypyrrole, polythiopene, poly(3,4-ethylenedioxythiophene), polyphenylene sulfide and a mixture thereof

8. The electrode according to claim 1, wherein the (semi-) conductive polymer is selected from polyacetylene, polyphenylene vinylene, polypyrrole, polythiopene, poly(3,4-ethylenedioxythiophene), polyphenylene sulfide and a mixture thereof.

9. The electrode according to claim 1, wherein the OER catalyst is a metal powder or a metal salt powder.

10. The electrode according to claim 1, wherein the OER catalyst is selected from Ru, Ir, Pd, Pt, Au, Ni, Fe, Os, Co, Mn, Zn and their alloys, oxides, respective mixed oxides and perovskites.

11. The electrode according to claim 9, wherein the OER catalyst is selected from metallic Ru, Ir, Pd, Pt, Au, Ni, Fe, Os, Co, Mn, Zn and their alloys.

12. The electrode according to claim 9, wherein the OER catalyst is selected from metallic Ru, Ir, Pd, Pt, Au, Fe, Os, Co, Mn, Zn and their alloys.

13. The electrode according to claim 9, wherein the OER catalyst is not a metal salt.

14. The electrode according to claim 1, wherein the OER catalyst is nickel on silica/alumina.

15. The electrode according to claim 1, wherein the weight ratio of the OER catalyst, the carbon material and the (semi-) conductive polymer in the coating is 50:10:40 to 80:4:16.

16. The electrode according to claim 1, wherein the substrate is carbon-based.

17. The electrode according to claim 1, wherein the substrate comprises graphite and, optionally, polypropylene.

18. An aqueous redox-flow battery comprising the electrode according to claim 1.

19. The aqueous redox-flow battery according to claim 18 comprising a flow cell comprising a positive electrode and a negative electrode, wherein the positive electrode comprises
a substrate, and
a coating applied to a surface of the substrate,
wherein the coating comprises a conductive carbon material, a (semi-)conductive polymer and, optionally, an oxygen evolution reaction (OER) catalyst.

20. A method for operating an aqueous redox-flow battery comprising the following steps:
(1) providing an aqueous redox-flow battery;
(2) operating the redox-flow battery in a charging/discharging mode;
(3) overcharging the redox-flow battery, thereby generating hydrogen gas;
(4) terminating overcharging of the redox-flow battery and discharging the redox-flow battery; and
(5) operating the redox-flow battery in a charging/discharging mode.

21. A method for generating hydrogen with an aqueous redox-flow battery comprising the following steps:
(1) providing an aqueous redox-flow battery;
(2) fully charging the redox-flow battery;
(3) continuing charging of the redox-flow battery after the battery is fully charged, thereby generating hydrogen gas;
(4) discharging the redox-flow battery; and
(5) optionally, operating the redox-flow battery in the charging/discharging mode.

22. The method according to claim 20, wherein in step (3) the potential is increased until a maximum potential is reached and, thereafter, the current flow is continued and the voltage remains at about the maximum potential until the end of step (3).

23. The method according to claim 20, wherein a positive electrolyte of the redox-flow battery is used in excess.

24. The method according to claim 20, wherein the aqueous redox-flow battery does not comprise additional catalytic beds.

25. The method according to claim 20, wherein at least one of a redox active species is an organic compound.

26. The method according to claim 20, wherein the redox-flow battery is an organic redox-flow battery.

27. The method according to claim 20, wherein electrodes of the redox-flow battery are carbon electrodes.

28. The method according to claim 20, wherein the aqueous redox-flow battery comprises an electrode comprising
a substrate, and
a coating applied to a surface of the substrate, wherein the coating comprises a conductive carbon material, a (semi-)conductive polymer and, optionally, an oxygen evolution reaction (OER) catalyst.

29. The method according to claim 28, wherein the electrode is a positive electrode of the aqueous redox-flow battery.

30. A method for operating the aqueous redox-flow battery according to claim 18, wherein the aqueous redox-flow battery is operated in a charging/discharging mode and in electrolyzer mode for production of gaseous hydrogen in an alternating manner.

31. The method according to claim 20, wherein the hydrogen gas produced in said method is removed from the aqueous redox-flow battery and stored separately from the liquid electrolytes of the aqueous redox-flow battery.

32. The method according to claim 31, wherein the hydrogen gas produced in step (3) is stored in geological underground.

33. The method according to claim 31, wherein the hydrogen gas produced in step (3) is stored in a salt cavern.

34. (canceled)

35. (canceled)
